(19) United States
(12) Patent Application Publication
(10) Pub. No.: US 2025/0327831 A1
(43) Pub. Date: Oct. 23, 2025

(54) WIND INDICATOR APPARATUS

(71) Applicant: WHIRLY PRO INDUSTRIES, A DIVISION OF REGGATTA SYSTEMS, INC., Santa Barbara, CA (US)

(72) Inventors: Anthony J. Blair, Santa Barbara, CA (US); Peter G. Blair, Santa Barbara, CA (US); Benjamin T. Massey, Santa Barbara, CA (US)

(21) Appl. No.: 19/179,839

(22) Filed: Apr. 15, 2025

Related U.S. Application Data
(60) Provisional application No. 63/635,456, filed on Apr. 17, 2024.

(51) Int. Cl. G01P 13/04; A63B 57/20; A63B 60/46

(52) U.S. Cl. CPC G01P 13/04; A63B 57/20; A63B 60/46; A63B 2209/08; A63B 2220/16; A63B 2220/76

(57) ABSTRACT

A wind indicator apparatus includes an elongated arm, a spindle extending vertically from the arm, and a directional indicator element coupled to the spindle and configured to rotate about a vertical axis to indicate wind direction. A tail extends upwardly from the directional indicator element and provides a surface for displaying advertising or promotional content. A base is detachably secured to the elongated arm and is configured to mount the apparatus to a structure or object. The apparatus may include modular and magnetically coupled components that facilitate customization, easy replacement, and enhanced safety. The wind indicator apparatus is particularly suited for use with golf carts but is adaptable to various other applications.

### CLAIM OF PRIORITY

The present Application for Patent claims priority to U.S. Provisional Application No. 63/635,456 entitled “Wind Indicator Apparatus”, filed Apr. 17, 2024, which is hereby expressly incorporated by reference.

### TECHNICAL FIELD

The present disclosure generally relates to an apparatus for measuring one or more characteristics of wind and, more particularly, to wind indicator apparatus for enabling a golfer to assess both the direction and velocity of the wind prior to taking their shot.

### BACKGROUND

A wind indicator apparatus is a tool used to determine the direction and strength of the wind. It typically consists of a conical textile tube, or a simple rotating arrow mounted on a pivot. The wind catches the fabric or arrow, causing it to point in the direction from which the wind is blowing. Wind indicators are commonly used in various contexts such as aviation, meteorology, sailing, and outdoor activities, such as golf, to assess wind conditions.

### SUMMARY

The following presents a simplified summary of one or more implementations in order to provide a basic understanding of some implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

According to one example, a wind indicator apparatus is provided. The wind indicator apparatus comprises an elongated arm; a spindle extending vertically from the elongated arm, the spindle configured to rotate about a vertical axis; a directional indicator element attached to the spindle, the directional indicator element configured to rotate with the spindle and indicate wind direction;
a tail extending upwardly from the directional indicator element, the tail comprising a surface for displaying advertisements or promotional content; and a base detachably secured to the elongated arm, the base configured for securing to a structure or object.

According to one aspect, the base includes one or more magnets for securing the apparatus to a metallic structure.

According to another aspect, the directional indicator element comprises a center opening located between and integrally connected to a first horizontal member and a second horizontal member.

According to yet another aspect, the spindle comprises a bottom portion shaft, where a first end of the shaft is integrally connected to, and extending upwardly from, the bottom portion and a second end of the shaft is configured to engage with the center opening of the directional indicator element.

According to yet another aspect, the second horizontal member of the directional indicator element includes a channel configured to receive the tail.

According to yet another aspect, the tail is removably attached to the directional indicator element to allow for interchangeable tails bearing different advertising or promotional content.

According to yet another aspect, the directional indicator element is magnetically attachable to a ferromagnetic surface, allowing the apparatus to be temporarily mounted apart from the base.

According to yet another aspect, the elongated arm includes a knurled texture adjacent the base to facilitate manual rotation and leveling of the apparatus.

According to yet another aspect, the elongated arm is balanced about a center of mass to enable free rotation about the vertical axis.

According to yet another aspect, the base and elongated arm are configured to support attachment of alternative objects in place of the directional indicator element.

According to yet another aspect, the apparatus comprises modular components, each configured to be removed and replaced without tools.

According to another example, the wind indicator apparatus comprises an elongated arm; a spindle extending vertically from the elongated arm, the spindle configured to rotate about a vertical axis; a directional indicator element attached to the spindle, the directional indicator element configured to rotate with the spindle and indicate wind direction; a tail extending upwardly from the directional indicator element, the tail providing a surface for displaying advertisements or promotional messages; and a base detachably secured to the elongated arm, the base configured for securing to a structure or object, and where one or more magnets detachably secure the elongated arm to the base. The directional indicator comprises a first horizontal member; a second horizontal member; and a center opening located between and integrally connected to the first horizontal member and the second horizontal member.

According to one aspect, the spindle comprises a bottom portion shaft, where a first end of the shaft is integrally connected to, and extending upwardly from, the bottom portion and a second end of the shaft is configured to engage with the center opening of the directional indicator element.

According to another aspect, the elongated arm includes a knurled texture adjacent the base to facilitate manual rotation and leveling of the apparatus.

According to yet another aspect, the directional indicator element is magnetically attachable to a ferromagnetic surface, allowing the apparatus to be temporarily mounted apart from the base.

According to yet another aspect, the elongated arm is balanced about a center of mass to enable free rotation about the vertical axis.

According to yet another aspect, the base and elongated arm are configured to support attachment of alternative objects in place of the directional indicator element.

According to yet another aspect, the apparatus comprises modular components, each configured to be removed and replaced without tools.

### BRIEF DESCRIPTION OF THE DRAWINGS

FIG. 1 illustrates a weather indicator apparatus attached to a golf cart, according to one aspect of the present disclosure.

FIG. 2 illustrates a top, right perspective view of a weather indicator apparatus, according to one aspect of the present disclosure.

FIG. 3 illustrates a top, left perspective view of the weather indicator apparatus of FIG. 2.

FIG. 4 illustrates a right-side view of the weather indicator apparatus of FIG. 2.

FIG. 5 illustrates a left-side view of the weather indicator apparatus of FIG. 2.

FIG. 6 illustrates a front plan view of the weather indicator apparatus of FIG. 2.

FIG. 7 illustrates a back plan view of the weather indicator apparatus of FIG. 2.

FIG. 8 illustrates a top plan view of the weather indicator apparatus of FIG. 2.

FIG. 9 illustrates a bottom plan view of the weather indicator apparatus of FIG. 2.

FIG. 10 illustrates an exploded view of the weather indicator apparatus of FIG. 2.

FIG. 11 illustrates the base of the weather indicator apparatus used as a lie+loft indicator.

FIG. 12 illustrates a weather indicator apparatus of the present disclosure secured to a pole in the ground.

### DETAILED DESCRIPTION

In the following description, specific details are given to provide a thorough understanding of the implementations described. However, it will be understood by one of ordinary skill in the art that the implementations may be practiced without these specific details. For example, certain aspects may be illustrated with simplified representations in order not to obscure the implementations in unnecessary detail. In other instances, well-known techniques may be shown in broad block form in order not to obscure the described implementations.

### Overview

The present disclosure relates to a wind indicator apparatus designed for versatile use, including but not limited to attachment on golf carts. The apparatus provides visual indication of wind direction as well as serves as a customizable promotional display.

The wind indicator apparatus comprises an elongated arm, a vertically oriented spindle, and a directional indicator element rotatably mounted on the spindle. A tail extends upwardly from the directional indicator element and is configured to display advertising, logos, or other promotional content. The tail may be interchangeable, allowing users to collect or customize it with different designs.

The wind indicator apparatus further comprises a detachable base configured to secure the apparatus to various structures, including metallic surfaces commonly found on golf carts. The components of the apparatus are modular and, in certain embodiments, magnetically attached, allowing for quick assembly, disassembly, and replacement. The magnetic coupling also serves as a safety feature by permitting a “break-away” function when the wind indicator apparatus is bumped or jostled, reducing the risk of injury or damage.

Additional features include a knurled surface on the base of the elongated arm for improved grip, a custom threaded spindle for secure and stable rotation, and a balanced arm structure to ensure smooth spinning in response to wind. In some embodiments, the elongated arm and base can support alternative attachments such as a cigar holder, expanding the functional scope of the wind indicator apparatus.

Overall, the apparatus combines utility, safety, and personalization in a compact and easily deployable form, making it suitable for both recreational and promotional applications

### Weather Indicator Apparatus

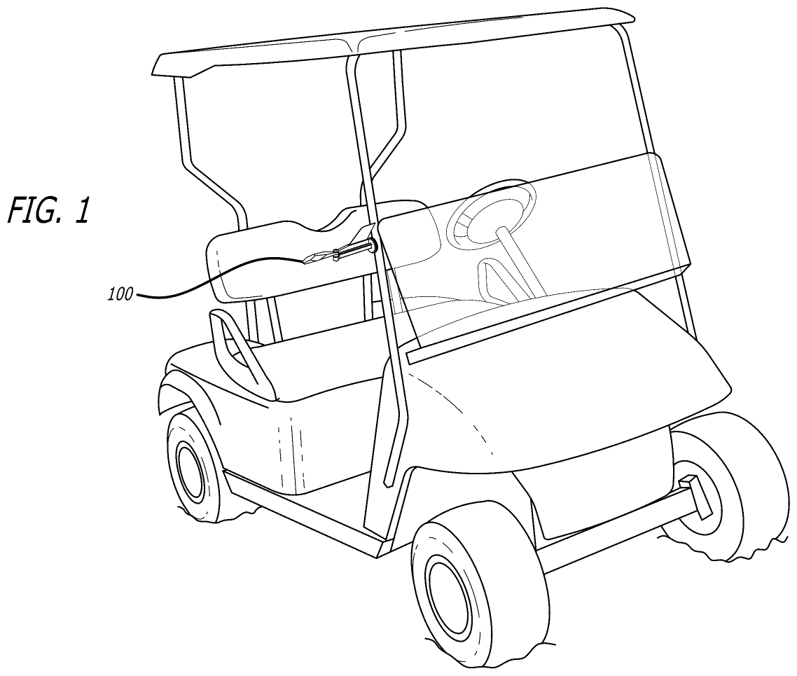

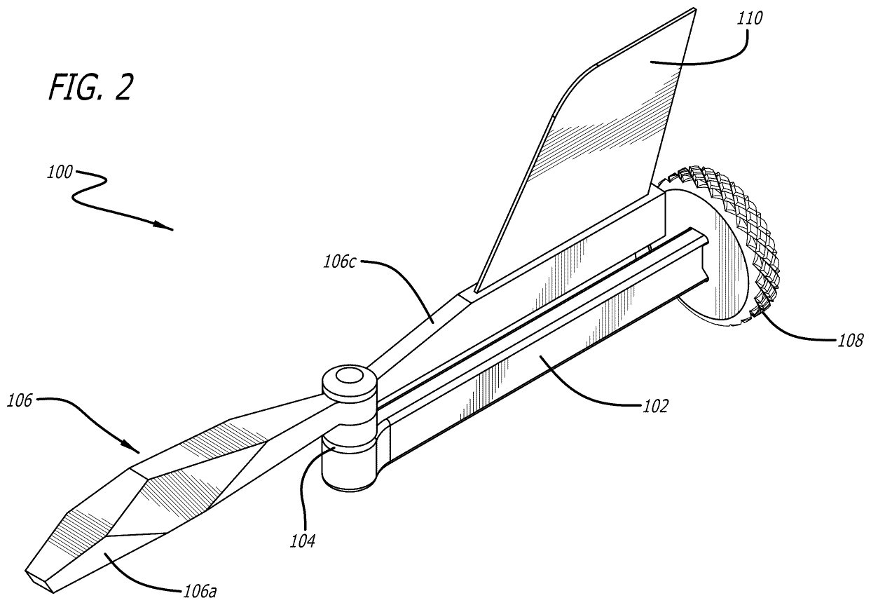

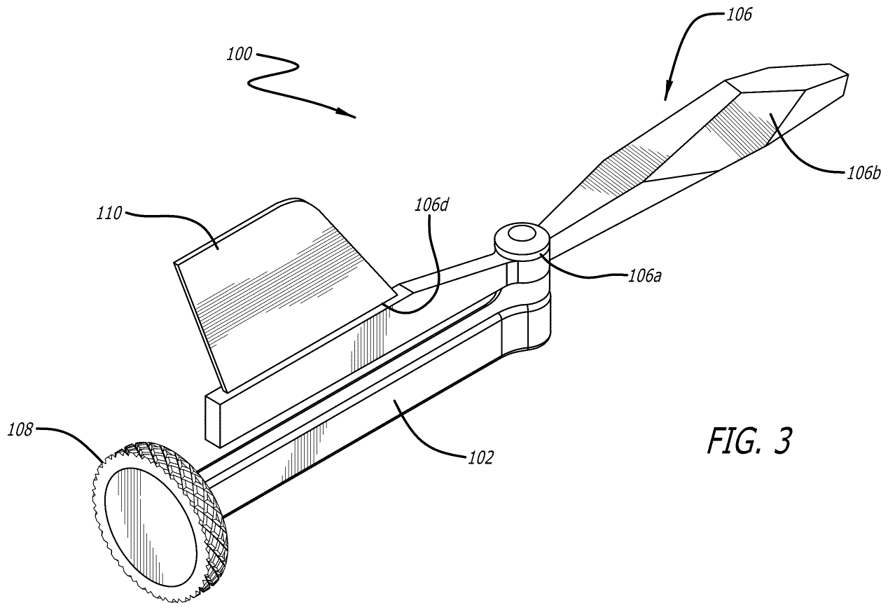

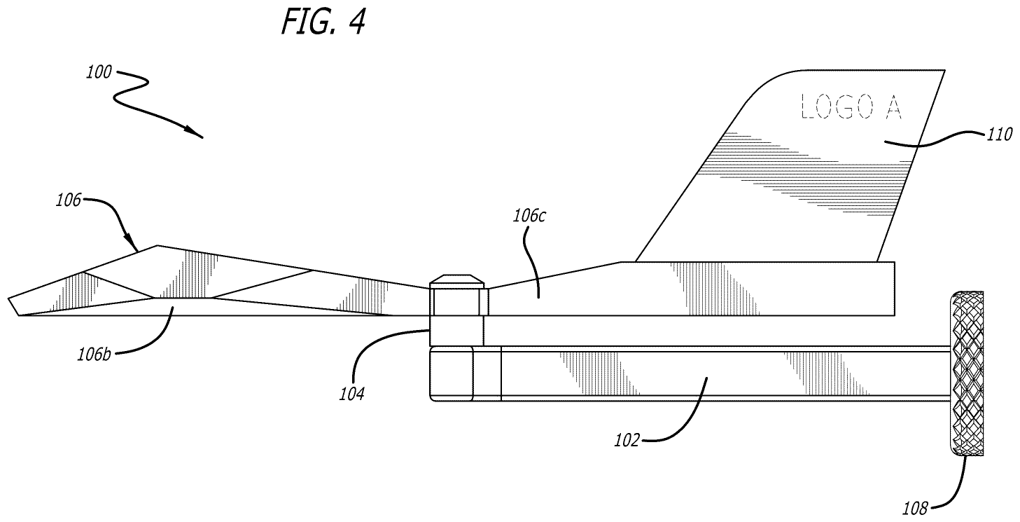

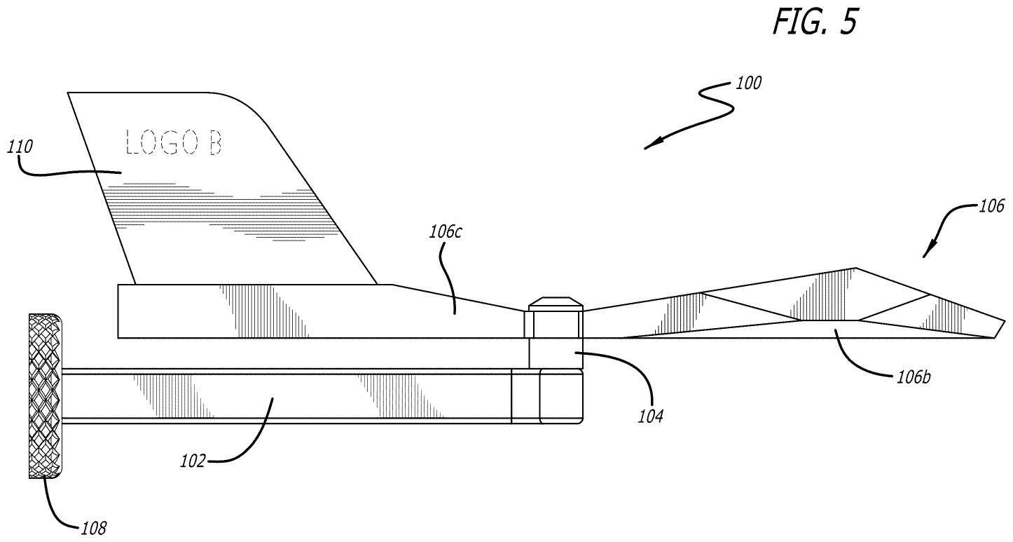

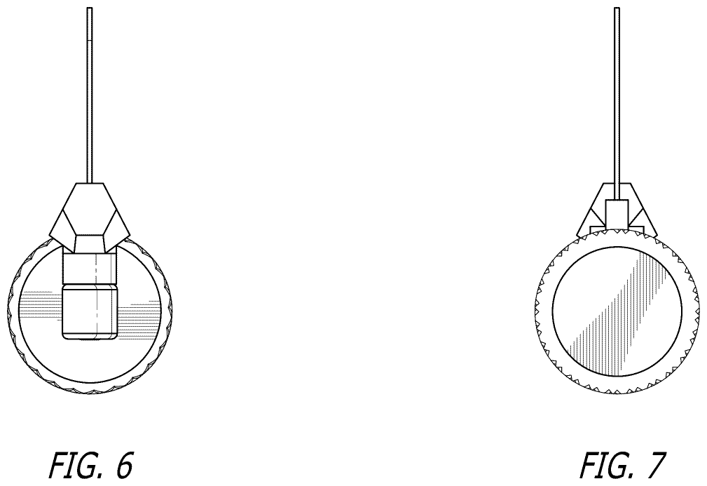

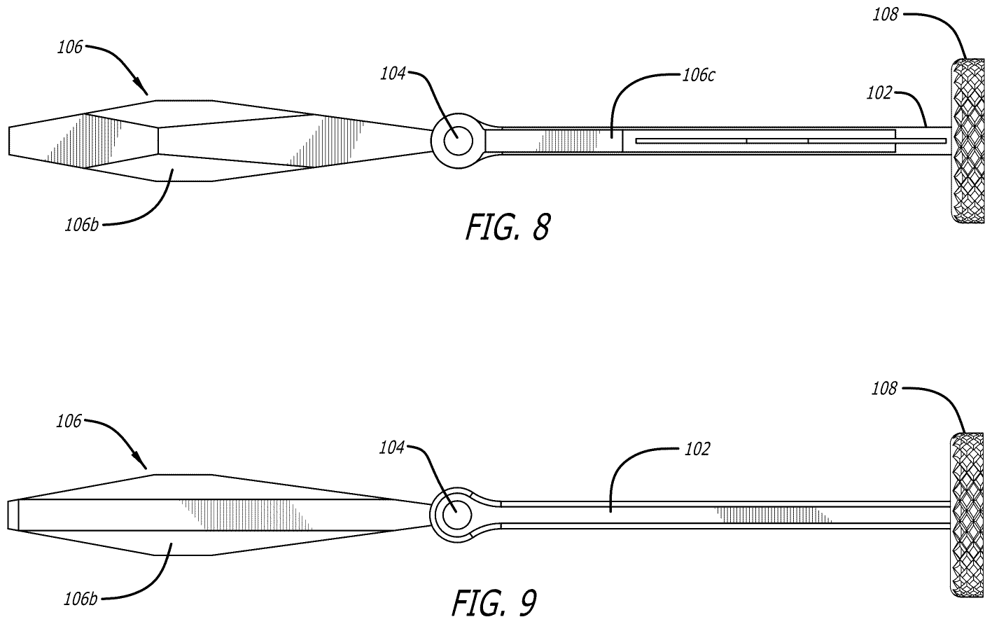

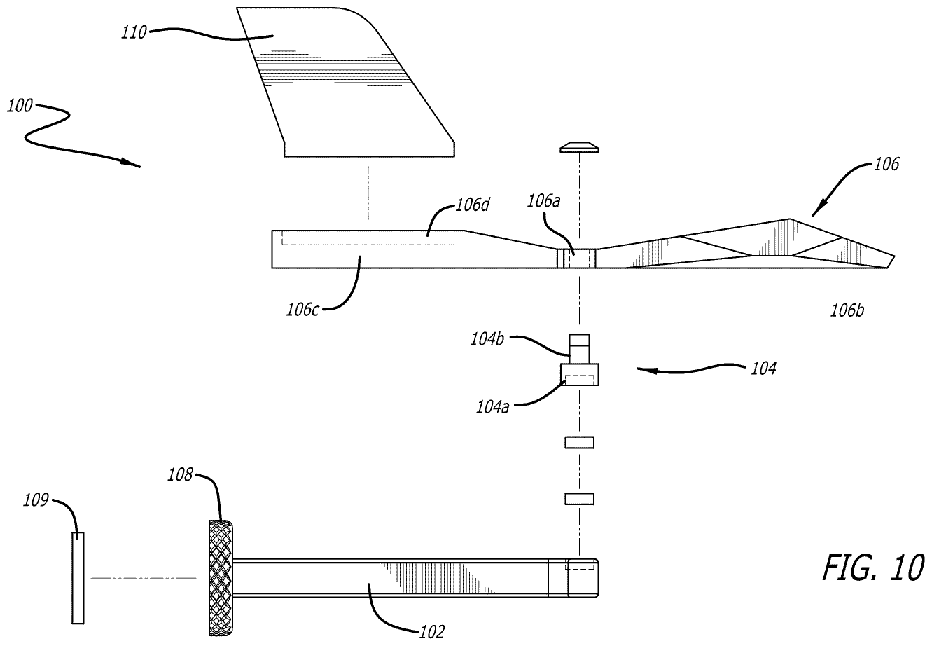

FIG. 1 illustrates a weather indicator apparatus 100 attached to a golf cart. FIG. 2 illustrates a weather indicator apparatus 100, according to one aspect of the present disclosure. FIG. 3 illustrates a top, left perspective view of the weather indicator apparatus of FIG. 2. FIG. 4 illustrates a right-side view of the weather indicator apparatus of FIG. 2. FIG. 5 illustrates a left-side view of the weather indicator apparatus of FIG. 2. FIG. 6 illustrates a front plan view of the weather indicator apparatus of FIG. 2. FIG. 7 illustrates a back plan view of the weather indicator apparatus of FIG. 2. FIG. 8 illustrates a top plan view of the weather indicator apparatus of FIG. 2. FIG. 9 illustrates a bottom plan view of the weather indicator apparatus of FIG. 2. FIG. 10 illustrates an exploded view of the weather indicator apparatus of FIG. 2. The following discussion refers interchangeably to FIGS. 1-10.

The weather indicator apparatus 100 comprises an elongated arm 102 and a spindle 104 extending vertically from the elongated arm, the spindle 104 being configured to rotate about its vertical axis. The spindle 104 includes a bottom portion 104a and a threaded shaft 104b. A first end of the threaded shaft 104b is connected to and extends upwardly from the bottom portion 104a, while a second end of the threaded shaft 104b is configured to engage with a corresponding threaded receptacle to facilitate rotational fastening. In one aspect, the bottom portion 104a may be integrally formed with the elongated arm 102.

A directional indicator element 106 is attached to the spindle 104 and configured to rotate with the spindle 104 and indicate the direction of the wind. A base 108 is secured to the elongated arm 102 and configured to secure the weather indicator apparatus 100 to a structure or object. The base 108 may be detachably secured to the elongated arm 102.

According to one aspect, one or more magnets 109 may be utilized to detachably secure the elongated arm 102 to the base 108. Utilizing magnets allows the assembly of components to “break-away” when jostled or bumped on the golf cart or any other object to which it is attached. This is also a safety feature, so someone does not get impaled on the directional indicator element of the weather indicator apparatus sticking out from the cart.

As shown, the directional indicator element 106 comprises a center opening 106a positioned between and integrally formed with a first horizontal member 106b and a second horizontal member 106c. The center opening 106a is configured to receive the threaded shaft 104b of the spindle 104 for rotational coupling.

According to one aspect, the second horizontal member 106c of the directional indicator element 106 includes a channel or slot 106d configured to receive a tail extending upwardly from the directional indicator element, the tail 110 providing a surface for displaying advertisements or promotional messages. The tail 110 can be readily removed from the channel 106d, allowing insertion of a different tail bearing an alternate advertisement or promotional message

According to one aspect, the elongated arm 102 includes a knurled texture to enhance grip and traction, facilitating user engagement when adjusting the wind indicator apparatus. For example, when the weather indicator apparatus 100 is mounted on an uneven surface, such as a sloped golf cart, the knurled texture aids in leveling the apparatus

To secure the directional indicator element 106 on the shaft 104b of the spindle 104 and prevent it from slipping off, a cap 112 may be engaged with the shaft either through the use of threads or a suitable snap connection. (see FIG. 10)

### Lie+Loft Indicator

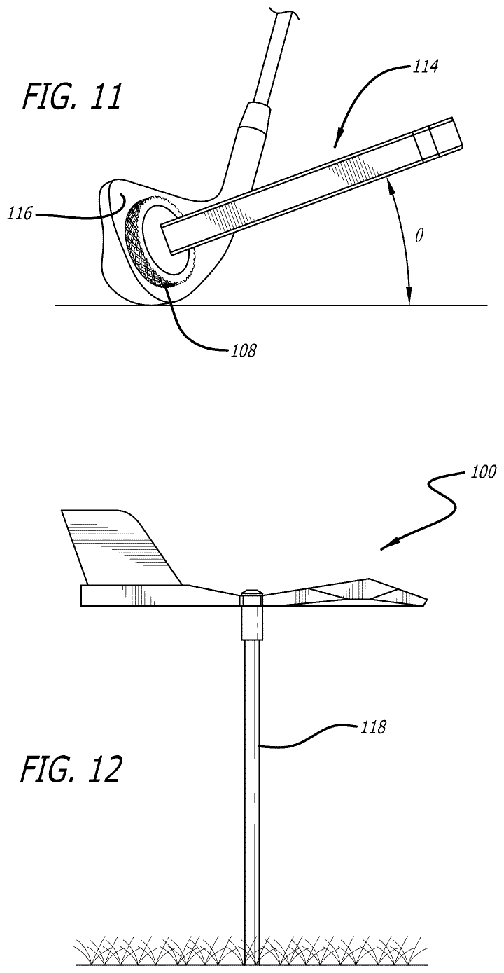

FIG. 11 illustrates the base 108 of the weather indicator apparatus used as a lie+loft indicator 114. A “lie+loft indicator” 114 is a device or tool-often used in golf-that helps measure or visualize two key aspects of a golf club's face 116 orientation: (1) Loft—The angle of the clubface relative to vertical, which affects how high the ball will launch; and (2) Lie—The angle θ between the club's shaft and the ground when the club is in a proper address position; it indicates whether the sole of the club sits flat on the ground.

To use as a “lie+loft indicator” 114, the user simply needs to disconnect the base 108 and snap the base 108 to the iron to view the launch angle and alignment. If the arm isn't pointing toward the target, chances are the ball won't fly on the desired trajectory.

### Alternative Mounting Configuration

FIG. 12 illustrates a weather indicator apparatus of the present disclosure secured to a pole in the ground. As shown, the weather indicator apparatus 100 may be secured to a vertical pole 118 positioned in the ground, demonstrating an alternative mounting configuration beyond golf cart use.

The weather indicator apparatus was initially developed for use with golf carts, but it may be utilized in a variety of other contexts. The weather indicator apparatus comprises a tail component configured to display logos, artwork, or promotional content, thereby allowing for customization and marketing opportunities. The tails may be collected and sold separately, similar to how poker chip ball markers are marketed in many professional golf shops.

The wind indicator apparatus further comprises a unique magnetic assembly that enables a “break-away” function when the wind indicator apparatus is bumped or jostled. This feature not only facilitates ease of reattachment but also serves as a safety mechanism to prevent injury from the directional indicator element protruding from a golf cart or other structure.

In certain embodiments, the directional indicator element is magnetically attachable to any ferromagnetic surface, allowing continued indication of wind direction independent of the original mounting location. The elongated arm may also be detached and magnetically affixed to a metallic golf club face to assist in visualizing loft and face angle.

To accommodate uneven mounting surfaces—such as when the apparatus is secured to an inclined golf cart—the base of the elongated arm includes a knurled texture to enhance grip and facilitate manual rotation. This feature allows a user to easily level the apparatus in a variety of installation conditions.

The apparatus may be mounted on any metallic surface of a golf cart or alternative structure, offering considerable installation flexibility. A custom, non-standard threaded spindle secures the elongated arm while enabling free rotation. The threads are specifically designed to mate with a cap through a central opening in the elongated arm, ensuring stability and ease of assembly.

The components of the weather indicator apparatus are modular and may be interchanged or replaced if damaged or if customization is desired. Each component, including the tail, spindle, and arm, is uniquely shaped and configured specifically for the apparatus.

The elongated arm is further designed with a balanced center of mass to allow for smooth, uninhibited rotation, thereby enhancing the accuracy and responsiveness of wind direction indication.

According to other aspects of the present disclosure, the elongated arm and base are not limited to use with a weather indicator apparatus. In certain embodiments, other objects—such as a cigar holder—may be mounted to the elongated arm, thereby expanding the functional versatility of the device.

While the foregoing disclosure shows illustrative aspects, it should be noted that various changes and modifications could be made herein without departing from the scope of the disclosure as defined by the appended claims. The functions, steps and/or actions of the method claims in accordance with the aspects described herein need not be performed in any particular order. Furthermore, although elements of aspects disclosed herein may be described or claimed in the singular, the plural is contemplated unless limitation to the singular is explicitly stated.

One or more of the components and functions illustrated in FIGS. 1-11 may be rearranged and/or combined into a single component or embodied in several components without departing from the invention. Additional elements or components may also be added without departing from the invention.

Aspects described in connection with a given description, illustration, representation, or method may be substituted for aspects described in a different description, illustration, representation, or method.

The word “aspects” does not require that all aspects of the disclosure include the discussed tab, advantage, or mode of operation.

The word “coupled” is used herein to refer to the direct or indirect coupling between two objects. For example, if object A physically touches object B, and object B touches object C, then objects A and C may still be considered coupled to one another—even if they do not directly physically touch each other.

The previous description of the disclosed embodiments is provided to enable any person skilled in the art to make or use the aspects described herein. Various modifications to these embodiments will be readily apparent to those skilled in the art, and the generic principles defined herein may be applied to other embodiments without departing from the spirit or scope of the invention. Thus, the disclosure is not intended to be limited to the embodiments shown herein but is to be accorded the widest scope consistent with the principles and novel aspects disclosed herein.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification.

1. A wind indicator apparatus, an elongated arm;
a spindle extending vertically from the elongated arm, the spindle configured to rotate about a vertical axis;
a directional indicator element attached to the spindle, the directional indicator element configured to rotate with the spindle and indicate wind direction;
a tail extending upwardly from the directional indicator element, the tail comprising a surface for displaying advertisements or promotional content; and
a base detachably secured to the elongated arm, the base configured for securing to a structure or object.

2. The wind indicator apparatus of claim 1, wherein the base includes one or more magnets for securing the apparatus to a metallic structure.

3. The wind indicator apparatus of claim 1, wherein the directional indicator element comprises a center opening located between and integrally connected to a first horizontal member and a second horizontal member.

4. The wind indicator apparatus of claim 3, wherein the spindle comprises a bottom portion and a threaded shaft, where a first end of the threaded shaft is integrally connected to, and extending upwardly from, the bottom portion and a second end of the threaded shaft is configured to engage with the center opening of the directional indicator element.

5. The wind indicator apparatus of claim 3, wherein the second horizontal member of the directional indicator element includes a channel configured to receive the tail.

6. The wind indicator apparatus of claim 1, wherein the tail is removably attached to the directional indicator element to allow for interchangeable tails bearing different advertising or promotional content.

7. The wind indicator apparatus of claim 1, wherein the directional indicator element is magnetically attachable to a ferromagnetic surface, allowing the apparatus to be temporarily mounted apart from the base.

8. The wind indicator apparatus of claim 1, wherein the elongated arm includes a knurled texture adjacent the base to facilitate manual rotation and leveling of the apparatus.

9. The wind indicator apparatus of claim 1, wherein the elongated arm is balanced about a center of mass to enable free rotation about the vertical axis.

10. The wind indicator apparatus of claim 1, wherein the base and elongated arm are configured to support attachment of alternative objects in place of the directional indicator element.

11. The wind indicator apparatus of claim 1, wherein the apparatus comprises modular components, each configured to be removed and replaced without tools.

12. A wind indicator apparatus,
an elongated arm;
a spindle extending vertically from the elongated arm, the spindle configured to rotate about a vertical axis;
a directional indicator element attached to the spindle, the directional indicator element configured to rotate with the spindle and indicate wind direction, and where the directional indicator comprises:
a first horizontal member;
a second horizontal member; and
a center opening located between and integrally connected to the first horizontal member and the second horizontal member;
a tail extending upwardly from the directional indicator element, the tail providing a surface for displaying advertisements or promotional messages; and
a base detachably secured to the elongated arm, the base configured for securing to a structure or object, and where one or more magnets detachably secure the elongated arm to the base.

13. The wind indicator apparatus of claim 12, wherein the spindle comprises a bottom portion and a threaded shaft, where a first end of the threaded shaft is integrally connected to, and extending upwardly from, the bottom portion and a second end of the threaded shaft is configured to engage with the center opening of the directional indicator element.

14. The wind indicator apparatus of claim 12, wherein the elongated arm includes a knurled texture adjacent the base to facilitate manual rotation and leveling of the apparatus.

15. The wind indicator apparatus of claim 12, wherein the directional indicator element is magnetically attachable to a ferromagnetic surface, allowing the apparatus to be temporarily mounted apart from the base.

16. The wind indicator apparatus of claim 12, wherein the elongated arm is balanced about a center of mass to enable free rotation about the vertical axis.

17. The wind indicator apparatus of claim 12, wherein the base and elongated arm are configured to support attachment of alternative objects in place of the directional indicator element.

18. The wind indicator apparatus of claim 12, wherein the apparatus comprises modular components, each configured to be removed and replaced without tools.
